(19) United States
(12) Patent Application Publication
(10) Pub. No.: US 2024/0239975 A1
(43) Pub. Date: Jul. 18, 2024

(54) HOME-COMPOSTABLE BIOPOLYESTER BLOWN FILM

(71) Applicant: Plastic Suppliers, Inc. dba Earthfirst, COLUMBUS, OH (US)

(72) Inventors: Tom Bowden, Columbus, OH (US); Ed Tweed, Columbus, OH (US)

(21) Appl. No.: 18/414,380

(22) Filed: Jan. 16, 2024

Related U.S. Application Data
(60) Provisional application No. 63/439,021, filed on Jan. 13, 2023.

(51) Int. Cl. C08J 5/18; C08J 3/205

(52) U.S. Cl. CPC C08J 5/18; C08J 3/2056; C08J 7/08; C08J 2367/04

(57) ABSTRACT

A method for producing a home compostable biopolyester blown film including a biopolyester and enzymes for improved compostability. Enzymes are added during the extrusion process. To maintain temperature, the blown film process is enclosed and uses a climate control system to maintain temperature and climate within the enclosures.

### CROSS-REFERENCE TO RELATED APPLICATIONS

This application claims priority to U.S. Provisional Application No. 63/439,021 titled “HOME-COMPOSTABLE BIOPOLYESTER FILM”, filed Jan. 13, 2023, the entire contents of which are incorporated by reference herein.

### FIELD OF THE DISCLOSURE

The present disclosure is generally related to a method for making a biopolyester blown film. Specifically, the biopolyester blown film is made using a climate-controlled enclosed process and includes enzymes and less than 2% plasticizers to make the biopolyester film home compostable, wherein the climate during the bubble and collapsing phases are controlled in order to allow for controlled cooling of the bubble and prevent defects or impurities. Furthermore, the enclosed climate-controlled process allows for temperature control to prevent destroying or damaging the enzymes as the enzymes are imperative for biopolyester films to be home compostable

### BACKGROUND

Biopolymers vary in terms of compostability. Some of the most popular and available biopolyesters such as PLA are only compostable in industrial facilities under specific conditions. There's a need in the market to provide solutions to move from industrial compostability to home compostability. One way to achieve this is through the introduction of enzymes that can facilitate the degradation of the biopolymer. However, the enzymes have narrow processing windows that may not be compatible with the current production methods of biopolyester. A system is needed for adding enzymes to a blown film production process within a narrow temperature band, without substantial plasticizer, and resulting in a usable product.

### SUMMARY OF THE INVENTION

Provided herein are home-compostable biopolyester blown films and methods of making the same. The methods include melting a bulk polymer material to form a molten mass having a first viscosity; increasing the viscosity of the molten mass to a second viscosity; applying one or more enzymes to the molten mass within a climate-controlled enclosure; forming a bubble from the molten mass within the climate-controlled enclosure; and collapsing the bubble to form a film within the climate-controlled enclosure. Increasing the viscosity of the molten mass may be accomplished by cooling the molten mass. The forming step may comprise include orienting the molten mass. The methods may further include annealing the biopolyester blown film. The methods may further comprise further drying the bulk polymer material prior to the melting.

The home-compostable biopolyester blown film may include a biopolyester selected from the group consisting of polyhydroxyalkanoate (PHA), polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof; a wax; and an enzyme. The blown film may further comprise a plasticizer in an amount of less than about 2% by weight of the blown film, or the blown film may be free of a plasticizer.

### BRIEF DESCRIPTIONS OF THE DRAWINGS

FIG. 1: Illustrates a biopolyester Blown Film Processing system.

FIG. 2: Illustrates a Blown Film Process.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The systems and processes described herein produce home-compostable biopolyester blown filmsby adding enzymes to the films during extrusion. The enzymes help break down the film when the film is composted. The enzymes therefore allow for home compostable biopolyester films. The temperature must be precisely controlled during the blown film process as not to exceed temperatures that might destroy the enzymes.

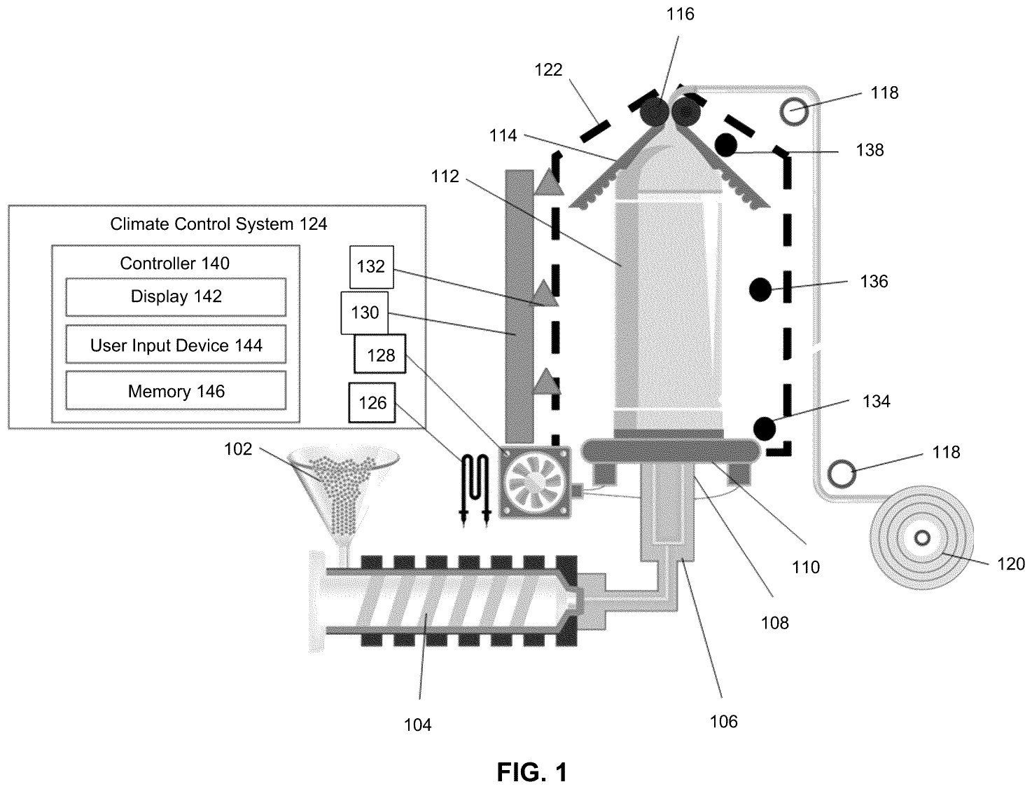

FIG. 1 shows a system for producing a biopolyester blown film. The system comprises of a hopper 102 to contain bulk polymer material such as polymer pellets, grains or beads, which tapers downward to a discharge point at the bottom where the bulk material is discharged into an extruder 104. The bulk polymer material may be dried in a variety of different ways, including, for example, drying in a dehumidifying hopper. In one embodiment, the hopper 102 may include a dehumidifying element, such as a dehumidifying hopper with hot air at a relatively low dew point may be used. However, a variety of air dryers are known in the art and many of them may be suitable for drying. The dehumidifying element need not be limited to air dryers only but may include other types of dryers, including baking or convection ovens. A dehumidifying hopper may be desirable in some embodiments, wherein dehumidified air passes through a bed of the bulk polymer material to extract moisture from the resin. The hopper may include a desiccant bed. A desiccant material, such as silica, absorbs moisture from the circulating air. Dual desiccant bed systems may be used, so that one bed is on-stream while the stand-by bed is being regenerated. Either a time cycle or a predetermined decrease in an air dew point is used to shift airflow from one bed to the other. Such methodology may remove some moisture that may reside below the surface of the bulk polymer material in addition to the surface moisture.

The extruder 104 receives the bulk polymer material from the hopper 102. The extruder 104 then extrudes the material through an annular die 108. During the extrusion process, the bulk polymer material is melted and homogenized before it is pumped through the annular die 108. The bulk polymer material is melted into a low viscosity molten mass, thus combining the heretofore individual polymer pellets, grains or beads into one molten mass. The viscosity of the melt will depend on the temperature. Temperatures can range from about the temperature at which the polymers will remain melted to about the temperature where degradation of the polymers begins to occur. By way of example, extrusion melt temperatures for biopolyester may be maintained between about 330° F. to about 380° F. for certain biopolyester blends, but may ultimately depend on the different polymers that have been blended and their respective melting points. In some embodiments, a broader range of about 325° F. to about 400° F. is preferred.

By way of example, the viscosity of biopolymers at about 480° F. and an apparent sheer rate of about 5.5 seconds⁻¹ in a capillary rheometer may range from about 1,000 poise (P, dyne/cm²) to about 8,000 P, preferably about 3,000 P to about 6,000 P, and more preferably, about 4,500 P. At a shear rate of about 55 seconds⁻¹, the same polymer at about 480° F. may have an apparent viscosity that ranges from about 1,000 P to about 5,000 P, preferably about 2,000 P to about 4,000 P, and more preferably, about 3,000 P.

A polymer cooler 106 conditions the temperature of the molten mass to increase the viscosity of the molten polymers, which makes the melt manageable for further processing. The cooling allows for the temperature of the extruded polymer to drop to a level at which the corresponding viscosity is high enough to allow a bubble 112 to be blown. By increasing the viscosity, a smoother film surface than without this step may be generated. A smoother surface aids in the printing process that is performed in many end applications, such as, for example, labels.

The polymer cooler 106 may include any cooler (i.e., heat exchanger) known in the art. The cooling medium may include air, liquids, or a polymeric coolant. For example, the viscosity of the polymer melt may be adjusted, alone or in combination, for example, by air cooling the die inner mandrel through which the polymer film is blown, the use of viscosity enhancers, controlling the die temperature with air or liquids, or polymer coolers.

The polymer cooler 106 may encompass a varied operating temperature range recognizing that higher temperatures may contribute to the degradation of the polymer. The temperature and duration of cooling can again depend on both the amount of polymer being cooled and the film properties that may be desired. In other terms, the pressure in the primary loop for polystyrene cooling is generally about 4000 psi to about 8000 psi. By contrast, the pressure in the same loop adjusted for biopolyester use may range from about 300 psi to about 4000 psi.

The extruded polymers demonstrate a substantial increase in viscosity upon cooling in the polymer cooler 106, which cooling procedure, in part, is thought to allow for the subsequent blowing of the film. The viscosity of the biopolyester polymers exhibits a consistent shear viscosity of a relatively large range of shear rates at any given temperature. The annular die 108 is used for the shaping the blown film. In this part of the system, the polymer melt is pre-cooled, preferably in a polymer cooler 106, and then submitted to a blown film orientation process. However, the viscosity of the polymer melt may also be adjusted, alone or in combination, for example, by air cooling the annular die 108 inner mandrel, the use of viscosity enhancers, and liquid thermoregulation of the annular die 108. The system of the present invention has at least one significant advantage in that a very controlled temperature—from the post extrusion temperature conditioning—can be achieved prior to the formation of a bubble. A blown film extrusion process extrudes molten polymer through the annular die 108 of circular cross-section and uses an air jet to inflate a bubble comprising the same.

Annular die 108 parameters may range from 1:0.75 BUR (Blown Up Ratio) to about 1:7.0 BUR, and preferably, about 1:4 BUR in the cross-web direction. In the length (or machine) direction, annular die 108 parameters may range from about 1:1 drawdown ratio to about 1:300 drawdown ratio, and preferably, about 1:130 drawdown ratio. Orienting temperatures of the present invention may range from about 100° F. to about 180° F., and more preferably, about 140° F.

As the molten polymer is extruded through the annular die 108 an air jet is used to inflate a bubble 112. Where a fine-tuning of temperature is desired, it can be relatively easily accomplished by a temperature-controlled air ring 110, which blows chilled air at the base of the bubble 112. In a preferred embodiment then, by virtue of pre-cooling the melted polymer, only a final fine-tuning of orienting temperature is performed, where desired, during the orientation process. In other words, the greater share of temperature conditioning takes place prior to orienting and not during orienting. Furthermore, as will be discussed later on, further control of the cooling process once the bubble 112 has been created can improve the final film product and allow for the use of other biopolymers and biopolymer blends.

Once the extrudate has been inflated into a circular bubble 112, it then is “collapsed” into a double thickness film. The collapsing process is performed by use of an “A-frame,” also known as a collapsing frame 114. These collapsing frame 114 uses primary nip rollers 116, panels, and/or flat sticks to flatten the bubble 112 into a sheet of double-thickness film. The sheets are ultimately cut and wound onto two finished rolls, or coils, or winder rollers 120 of biopolyester film. The sheets of film may also be cut to the desired length.

The primary nip rollers 116 flatten the bubble into a sheet of double-thickness film. The sheets are ultimately cut and wound onto two finished rolls, or coils, of a polymer film. The sheets of film can also be cut to the desired length. In one embodiment the primary nip rollers 116 may be placed and designed in such a way that they would not allow any air to pass through. The primary nip rollers 116 would be placed at the very top of the enclosure 122 when the film process is oriented in a vertically upward direction. By limiting air from escaping through the primary nip rollers 116 the internal temperature of the enclosure may be better controlled. Secondary nip rollers 118 are located after the primary nip rollers 116 to assist with moving the film along the line. In another embodiment, additional nip rollers may be included to further assist in moving the film along the production line. The winder rolls 120, coils, or winds the collapsed film after coming through the secondary nip rollers 118.

The enclosure 122 is a casing or exterior shell that encloses the blown film process. The enclosure 122 encases the film blowing process from the annular die 108 up to the primary nip rolls. The enclosure 122 surrounds the blown film tower and includes at least one heating/cooling element 126 to maintain an optimal temperature for the blown film process. In another embodiment, the enclosure 122 does not encase the entire film blowing process but starts just after the bubble 112 is formed and encases the process up to the primary nip rollers 116. In another embodiment, the enclosure 122 is separated into several zones where the temperature in each zone is monitored and controlled separately in each zone by temperature sensors (134, 136, 138) and air ducts 130 and air vents 132.

By enclosing the bubble 112 as it is being created or just after providing more control over the heating/cooling of the film. With the enclosure 122, the temperature or climate (i.e. humidity) of or around the blown film may be controlled through the entire process. This is novel in the blown film process and further allows for a wider range of polymer/biopolymers or blends to be used in the blown film process. Without an enclosure 122 controlling the climate around the bubble 112, some polymers may collapse too quickly or not quickly enough causing defects, impurities, or tearing of the film.

The climate control system 124 is used to maintain optimal temperatures and humidity within the enclosure. The climate control system 124 includes one or more heating/cooling elements 126, a blower 128, air ducts 130, air vents 132, a first temperature sensor 134, a second temperature sensor 136, a third temperature sensor 138, and a controller 140. The climate control system 124 may be located outside of the enclosure 122.

In another embodiment, the climate control system 124 may dehumidify the bulk polymer material while in the hopper 102 as polymers and biopolymers are known to absorb or attract moisture. In such embodiments, the air ducts 130 and air vents 132 may be configured to direct heated air to the hopper 102. Furthermore, the climate control system 124 controls humidity throughout the entire process.

The heating/cooling element 126 may include a heating electric coil or use other means of heating air. Alternatively, the heating/cooling element 126 may include an air conditioning unit to cool the air. In another embodiment, the climate control system 124 includes at least two heating/cooling elements 126, which would allow the climate control system 124 to control the temperature of the air moving to different sections of the enclosure 122. A heating/cooling element 126 for each temperature sensor may be included to allow for individual control of temperature to each section of the enclosure where each temperature sensor is located.

The blower 128 is used to move heated or cooled air from the heating/cooling element 126 through the air ducts 130 and air vents 132 to different sections of the enclosure 122. In another embodiment, the climate control system 124 includes at least two blowers 128. In yet another embodiment, the climate control system 124 includes one blower 128 for each of the temperature sensors so that air may be individually forced or routed to the area of each temperature sensor. The air ducts 130 channel heated or cooled air from the heating/cooling elements 126 and blowers 128 to different portions of the enclosure 122. This allows for heated forced air to be distributed and directed to different sections of the enclosure 122 to ensure ideal climate control throughout the enclosure 122.

For example, a blown film system may benefit from maintaining a certain temperature through the initial phase of the bubble phase and then cooled quickly just before being collapsed or during the collapsing process. In the systems of the present disclosure, the climate control system 124 may maintain a certain temperature during the first phase of the bubble formation process and then inject cooler air via the air ducts 130 towards the end of the process or as the bubble is collapsed. The air vents 132 open from the air ducts 130 and help direct and regulate the airflow into the enclosure 122. The air vents 132 may be controlled by the controller 140 to help direct airflow by opening and closing the air vents 132 or directing the airflow.

In the embodiment shown in FIG. 1, a first temperature sensor 134 monitors temperature within the enclosure 122. A temperature sensor is an electronic device that measures the temperature of its environment and converts the input data into electronic data to record monitor or signal temperature changes. There are many different types of temperature sensors. Some temperature sensors require direct contact with the physical object that is being monitored (contact temperature sensors), while others indirectly measure the temperature of an object (non-contact temperature sensors). The first temperature sensor 134 is one of at least three sensors that are located at a different point within the enclosure 122. In one embodiment the first temperature sensor 134 is located just above the air ring 110 but before the bubble 112 is fully formed. The first temperature sensor 134 monitors the temperature within the enclosure 122 just above the air ring 110. The monitored temperature is electrically communicated (e.g., wired or wirelessly, including WiFi, Bluetooth, or other transmission mediums) to the controller 140 which uses the temperature data to regulate air temperature within the enclosure at the location 122.

A second temperature sensor 136 monitors the temperature within the enclosure 122. The second temperature sensor 136 is one of at least three sensors that are located at a different points within the enclosure 122. In one embodiment the second temperature sensor 136 is located at a mid-point of the enclosure 122. In another embodiment where the enclosure 122 doesn't fully enclose the process down to the air ring 110, the second temperature sensor 136 may be located a point just as the bubble 112 enters the enclosure 122. The second temperature sensor 136 monitors the temperature and the monitored temperature is electrically communicated (e.g., wired or wirelessly, including WiFi, Bluetooth, or other transmission mediums) to the controller 140 which uses the temperature data to regulate air temperature within the enclosure 122 at the location of the second temperature sensor 136.

A third temperature sensor 138 monitors temperature in the enclosure 122. The third temperature sensor 138 is one of at least three sensors that are located at a different points within the enclosure 122 along the film blowing process. In one embodiment the third temperature sensor 138 is located just before the primary nip rollers 116 just before the bubble 112 is collapsed. The third temperature sensor 138 monitors the temperature within the enclosure 122 just before the primary nip rollers 116. The monitored temperature is electrically communicated (e.g., wired or wirelessly, including WiFi, Bluetooth, or other transmission mediums) to the controller 140 which uses the temperature data to regulate air temperature within the enclosure 122 at the location of the third temperature sensor 138.

The controller 140 includes a display 142, a user input device 144 or user interface, and a memory 146. The controller 140 is used to program and control the climate control system 124. A user may select pre-stored settings or enter in a specific setting and the controller then monitors the temperature data from the temperature sensors (134, 136, 138). Depending on data received from the sensors, the controller 140 may adjust heat or cooling and airflow entering the enclosure 122 by increasing or decreasing the temperature of air using the heating/cooling elements 126, increasing or decreasing the air flow rate of the blower 128, and opening or closing the air vents 132.

The display 142 is used to display data and user inputs. Displayed data may include, but are not limited to, sensor data, such as temperature, blower or fan speeds, or other data related to the film blowing process. The user input device 144 or user interfaces are well known in the art and may include, but are not limited to, keyboards, touch screens, voice, or other connected devices, such as smartphones or tablets. The memory 146 is a device or system that is used to store information for immediate use in a computer or related computer hardware and digital electronic devices. The term memory is often synonymous with the term primary storage or main memory. The memory 146 stores data from the sensors and other devices connected to the film blowing process. Furthermore, the memory 146 stores user input information from the user input device 144, a preset configuration such as temperature ranges or thresholds, and executable code or modules.

The biopolyester blown film is a blown film that includes enzymes and less than 2 wt % of a plasticizer. Typically, biopolyester blown films are only industrially compostable. The addition of enzymes to the biopolyester blown film helps to compost the film, thereby making it more amenable to home composting. The enclosed blown film process described herein allows for a climate-controlled process where the temperature during the extrusion, bubble, and cooling processes may be controlled allowing for a higher quality finished product with fewer defects or inconsistency. This temperature control also essential to prevent destroying the enzymes.

One example of a biopolyester blown film includes a film blown from at least one polyester selected from polyhydroxyalkanoate (PHA), polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof. The at least one polyester is included in the bulk polymer material in the form of pellets, grains, or beads. In some embodiments, the at least one polyester includes PHA.

Plasticizers, such as adipate, adipic acid, glycerol ester, and adipic acid ester, may be added to the biopolyester blown film. The plasticizers may comprise less than 2 wt % of the blown film, such as less than 1%, or less than 0.1%. In some embodiments, the blown film may not comprise any plasticizer. The plasticizer may be included in the bulk polymer material as a pellet, bead, or grain.

The enzymes refer to active enzymes or enzyme-producing microorganisms, such as sporulating microorganisms, as well as combinations thereof. The enzymes may be in solid (e.g., powder) or liquid form. The enzymes improve the compostability of the biopolyester blown film. Furthermore, due to the fact that enzymes are biologics or microorganisms, they are sensitive to temperatures and other environmental conditions, including the temperatures required during the blown film process. The high temperature or fluctuations in temperature may damage or destroy the enzymes. To mitigate this damage, the enzymes are added to the film during or directly after extrusion of the molten mass. Furthermore, the enclosure 122 and climate control system 124 further mitigate damage to the enzymes by precisely controlling the temperature during the blown film process.

The blown film may also include a wax. The wax is an additive to the PHA blown film which reduces the stickiness of the PHA blown film. The wax additive may include, but is not limited to, an EBS (ethylene-bis staramide) synthetic wax. In one embodiment, the wax may also be the slip additive and provide benefits for both reduced stickiness and reduced friction or the blown film.

The blown film may also include a slip additive. Slip additives are modifiers that act as an internal lubricant to reduce the coefficient of friction (COF) between two overlapping films, for example, in films rolled after production. Indeed, lower COFs are especially desirable for film applications. These additives migrate to the surface of the plastic during and immediately after processing. That is, a non-visible coating “blooms” to the surface to provide a microscopic “layer” of “lubricant” between two adjacent sheets of film. In this way, enhanced lubricity and slip characteristics are provided. The previously described climate-controlled enclosure allows for some control over the migration of the slip additive.

Accordingly, slip additives may be considered similar to antiblock additives (discussed further below) in that they both serve to lower the COF between two overlapping films. Films of the instant invention may comprise one, both, or neither class of additives. Typical slip additives include, for example, oleamide, erucamide, stearamide, behenamide, oleyl palmitamide, stearyl erucamide, ethylene bis-oleamide, N,N′-Ethylene Bis(Stearamide) (EBS), including most grades of their respective refinement. In some embodiments, EBS is a preferred slip agent, and EBS with 4032D carrier is more preferred. EBS is sold under the tradenames Advawax, Lubrol EA, and Micotomic 280.

The “active ingredient” of slip additives is generally supplied with a carrier. Films of the present disclosure may comprise less than about 1 percent by weight of a slip additive (referring to the “active ingredient” only), and more preferably less than about 0.5 percent by weight. It should be noted that excessive amounts of slip additives may produce films that are excessively smooth, which can compromise the ability of substances (e.g., ink, stickers, etc.) to adhere to the surface of the PHA film. Thus, to enhance, for example, the printing properties of shrink films of the instant invention, the amount of slip additive may require adjustment accordingly.

The blown film may also include an antiblock additive. Antiblock (also called “antitack”) additives serve to improve the processing and application of polymer films. Specifically, this class of additives is used to reduce the adhesion between films. Antiblock additives-typically finely divided, solid minerals-act by producing a slight roughening of the surface. Antiblock additives are typically “loaded” with a carrier compound. While it is by no means a requirement, it is preferable that the carrier compound be similar to or equivalent to one or all of the polymers in the PHA blend base. In the instant invention, for example, it is preferred that the carrier compound be a PHA polymer. As the “active ingredient” in an antiblock comprises only a small fraction of the final composition, adding a carrier compound provides ease and consistency in measurements. One having ordinary skill in the art would recognize to take the concentration of the carrier compound into account when calculating the final concentration of antiblock additive in the final product. For example, if a composition comprising 10 percent antiblock additive consists of 10 percent “active ingredient,” the final concentration of the “active ingredient” is 1.0 percent of the total.

One example of an antiblock additive includes a silica additive. There are some benefits between adding antiblock additives such as silica and slip additives. Adding silica not only reduces blocking but allows less slip to be added to achieve the target coefficient of friction. Some types of antiblock additives, such as calcium carbonate, have been found to absorb slip additives, increasing the coefficient of friction. High levels of silica and other inorganic additives can result in a high haze. This can be alleviated by confining the inorganic additive to a thin our layer. Inorganic additives like talc, carbonates, and anhydrates, have also been reported to react with some slip additives, resulting in degradation by-products with color or odor/taste issues. Other types of antiblock agents include paraffinic, ethylene and propylene oxide synthetics, fatty acid soaps, fatty acid amides, and silicons in addition to the aforementioned silicates.

The blown film may also include one or more processing aids inclusive of additives that lower the surface friction of films, allowing the film to be rapidly extruded and then shipped or stored in rolls. They may also allow the resin to be converted easily in blown-film processes or thermoforming processes. Processing aids include several different classes of materials used to improve processability and handling. One such example of a processing aid is polyethylene glycol (PEG). Other low molecular weight polyethylene glycols might be used. One example of a processing aid is a viscosity enhancer. Other processing aids as known in the art might be utilized inclusive of PFAS-free polymers and fluoropolymer compounds.

Although numerous methods are known and available to increase the viscosity of polymers during the processing of blown films, the term “viscosity enhancer” is defined herein to encompass any chemical agent that increases or maintains the viscosity of a polymer at a given temperature. Viscosity enhancers may be introduced into the polymer blend at any time until the polymer enters the enclosure 122; however, viscosity enhancers are preferably introduced prior to extrusion, and more preferably, during blending of the bulk polymer material.

Viscosity enhancers inclusive of copolymers of styrene, methyl methacrylate and glycidyl methacrylate can improve the finished properties of films by preventing and/or reversing the degradation encountered during the processing of polymer films. Some viscosity enhancers are “stabilizers.” That is, they are used in virgin plastic to either (1) protect against degradation in processing and/or (2) reverse the degradation caused by recycling, and return the plastic to nearly its original performance properties. Another class of viscosity enhancers, “coupling agents,” for example, improves the processability of the extruded polymer by “coupling” individual polymer strands thereby increasing the melt strength of the plastic.

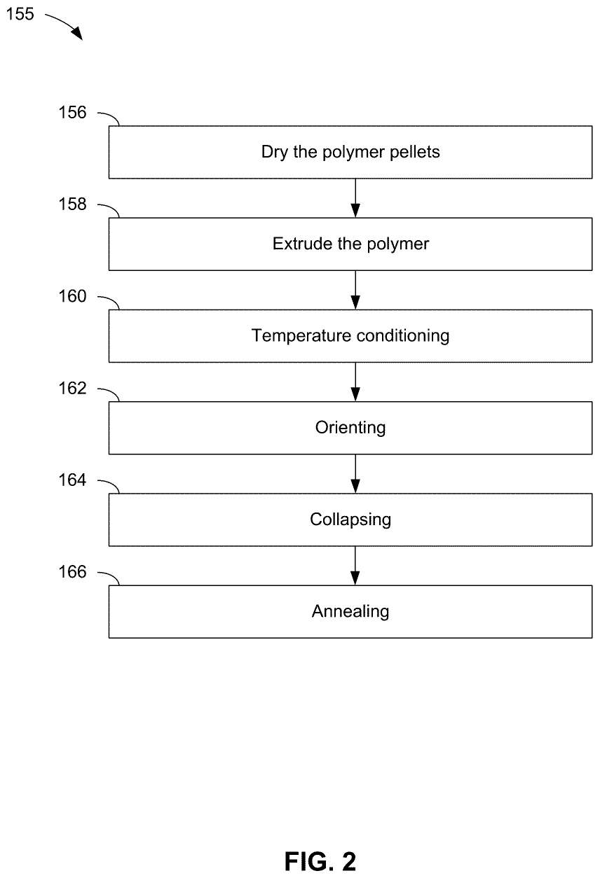

FIG. 2 shows a process 155 for preparing a blown film. The drying step 156 removes moisture from the bulk polymer material including the PHA base blend. Biopolyester readily absorbs moisture from the atmosphere and therefore, the blended polymer pellets are preferably first dried by heating in a dryer to remove surface moisture. Without being bound by or limited to theory, it is believed that the removal of moisture content may help control the relative viscosity loss due to hydrolysis. High temperatures and the presence of even a small amount of moisture can hydrolyze biopolyester in the ensuing melt phase.

A dehumidifying hopper with hot air at a relatively low dew point may be used to perform the drying step 156; however, a variety of air dryers are known in the art and many of them may be suitable for drying. The present invention need not be limited to air dryers only but may include other types of dryers, including baking ovens. A dehumidifying hopper may be desirable in some embodiments in that dehumidified air passes through a bed of biopolyester to extract moisture from the resin. A desiccant material, such as silica, absorbs moisture from the circulating air. Dual desiccant bed systems are common, so that one bed is on-stream while the stand-by bed is being regenerated. Either a time cycle or a predetermined decrease in air dew point is used to shift airflow from one bed to the other. Such methodology is thought to be effective in removing some moisture that may reside below the surface of the bulk polymer material in addition to the surface moisture.

Dew point is an absolute measure of air moisture and is independent of air temperature. Dew point may be adjusted to control dryer performance. Airflow is another component of drying, as it heats the resin and absorbs its moisture. Sufficient airflow may maintain the resin at the proper temperature for its entire residence time. In embodiments where additional colorants, additives, or otherwise ingredients are used, it may be preferable to minimize moisture-related degradation by further drying the same.

Preferable dryers of the instant invention for drying biopolyester may have one or more of the following characteristics:
1. Desiccant beds capable of achieving a dew point of about −40° C. in the supply air.
2. A means, e.g., an after-cooling unit, to eliminate or reduce the likelihood of temperature spike in the supply air.
3. Excellent temperature control in the biopolyester drying range.

The temperature and duration of drying may depend on the total amount and condition of the polymer(s) (i.e., the amount of starting surface moisture), and may need to be adjusted on a batch-by-batch basis. Preferably, the polymers experience little to no melting in this step. By way of example, typical drying conditions require a moisture content of less than 0.04% by weight (400 ppm) to prevent viscosity degradation during processing. In some embodiments a moisture content of less than about 200 ppm is preferable, and less than about 50 ppm may be more preferable (measured by the Karl Fisher method). Drying conditions of 4 hours at no greater than 170° F. (80)° ° C. or at a dew point of −40° F. (−40° C.) with an airflow rate greater than 0.5 cfm/lb of polymer. The bulk polymer material may not be exposed to atmospheric conditions after drying, and the hopper may be kept sealed until ready to use. Higher drying temperatures may lead to softening and blocking of polymer, while lower drying temperatures may result in extended drying times and/or incomplete drying.

In the extrusion step 158 the bulk polymer material is melted into a low viscosity molten mass, thus combining the heretofore individual polymer pellets, beads or grains into one molten mass. The viscosity of the melt will depend on the temperature. Temperatures can range from about the temperature at which the polymers will remain melted to about the temperature where degradation of the polymers begins to occur. By way of example, extrusion melt temperatures may be maintained between about 320° F. to about 400° F. for certain biopolyester polymer blends but may ultimately depend on the different polymers that have been blended and their respective melting points. In some embodiments, about 330° F. to 380° F. is preferred. Furthermore, during the extrusion step 158, the enzymes are added at which point the temperature may be maintained between 320° F. to 340° F. to prevent damaging or destroying the enzymes.

The temperature conditioning step 160 may be accomplished by a variety of methods known in the art. Generally, the temperature conditioning step 160 comprises cooling the molten mass. For example, the viscosity of the polymer melt may be adjusted, alone or in combination, for example, by air cooling the die inner mandrel through which the polymer film is blown, the use of viscosity enhancers noted above, controlling the die temperature with air or liquids, or polymer coolers such as polymer cooler 106. The temperature conditioning step may be further continued during the bubble process within the enclosure using 122 the climate control system 124.

The polymer cooler 106 operating temperature range may be between about 320° F. to about 360° F. Higher temperatures may be used, but such higher temperatures may also contribute to the degradation of the polymer. The temperature and duration of cooling may again depend on both the amount of polymer being cooled and the film properties that may be desired. In other terms, the pressure in the primary loop for polystyrene cooling is generally about 1000 psi to about 7,000 psi and, in some instances, about 5,000 psi; by contrast, the pressure in the same loop adjusted for biopolyester use may range from about 300 psi to about 4,000 psi.

The polymers demonstrate a substantial increase in viscosity upon cooling in the polymer cooler, which cooling procedure, in part, is thought to allow for the subsequent blowing of the film. It is also apparent that the viscosity of the biopolyester polymers exhibits a consistent shear viscosity of a relatively large range of shear rates at any given temperature.

The process 155 continues with an orienting step 162, also known as stretching, can be accomplished by methods and associated equipment known to those of ordinary skill in the art, including, for example, machine/cross direction orientation and blown film orientation. All methods are preferably designed to first control the temperature of the polymer, followed by a controlled stretching operation. Without being limited to or bound by theory, it is believed that the orienting process conveys strength and flexibility to the film product. Furthermore, though orientation bubbles may be pulled both up or down from a die, it may be preferable to pull said bubble upward to facilitate control and maintenance of the polymer temperature during orientation.

In a preferred embodiment of the present invention, the polymer melt is already pre-cooled, preferably in a polymer cooler, and then submitted to a blown film orientation step. However, the viscosity of the polymer melt may also be adjusted, alone or in combination, for example, by air cooling the die inner mandrel, the use of viscosity enhancers, and liquid thermoregulation of the die.

Die parameters may range from 1:0.75 BUR (Blown Up Ratio) to about 1:7.0 BUR, and preferably, about 1:4 BUR in the cross-web direction. In the length (or machine) direction, die parameters may range from about 1:1 drawdown ratio to about 1:300 drawdown ratio, and preferably, about 1:130 drawdown ratio. Orienting temperatures of the present invention range from about 100° F. to about 180° F., and more preferably, about 140° F.

In the preferred embodiment then, by virtue of pre-cooling the melted polymer, a final fine-tuning of orienting temperature may be performed, where desired, during the orientation process. In other words, the greater share of temperature conditioning may take place prior to orienting and not during orienting. Where a fine-tuning of temperature is desired, it may be accomplished by a temperature-controlled air ring, which blows chilled air at the base of the bubble.

In another embodiment, the fine-tuning of the orienting temperature may be performed through the entire orienting step 162 until the collapsing step 164 by controlling the climate within the enclosure 122 with the climate control system 124 during the orienting step 162. The 164 collapsing step is the fifth step in the process. Once the extrudate has been inflated into a circular 112 bubble, it then is “collapsed” into a double thickness film. The collapsing process is performed by use of an “A-frame,” also known as a collapsing frame 114. This frame uses primary nip rollers 116, panels, and/or flat sticks to flatten the bubble 112 into a sheet of double-thickness film.

In accordance with another teaching of the present invention, it has also been observed that maintaining the film temperature within a preferred range while in bubble form may prevent the formation of undesirable wrinkles and/or film layers that stick together upon passage through the nip rollers.

The process 155 proceeds with a collapsing step 164. Once the extrudate has been inflated into a circular bubble 112, it then is “collapsed” into a double thickness film. The collapsing process is performed by use of the collapsing frame 114. The collapsing frame 114 uses primary nip rollers 116, panels, and/or flat sticks to flatten the bubble 112 into a sheet of double-thickness film. The sheets are ultimately cut and wound onto two finished rolls of PHA film as described above.

The process continues with an annealing step 166, also called crystallization. Annealing is generally accomplished after the orienting step 162, and performed at temperatures between about 120° F. to about 285° F. in some embodiments.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.”

### ENUMERATED EMBODIMENTS

Embodiment 1: A method of making a home-compostable biopolyester blown film, the method comprising: melting a bulk polymer material to form a molten mass having a first viscosity; increasing the viscosity of the molten mass to a second viscosity; applying one or more enzymes to the molten mass within a climate-controlled enclosure; forming a bubble from the molten mass within the climate-controlled enclosure; and collapsing the bubble to form a film within the climate-controlled enclosure.

Embodiment 2: The method of embodiment 1, wherein the bulk polymer material includes a biopolyester selected from the group consisting of polyhydroxyalkanoate (PHA), polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof.

Embodiment 3: The method of embodiment 2, wherein the biopolyester includes PHA.

Embodiment 4: The method of any one of embodiments 1-3, wherein the bulk polymer material includes a plasticizer in an amount of less than 2% by weight.

Embodiment 5: The method of any one of embodiments 1-4, wherein the bulk polymer material is free of a plasticizer.

Embodiment 6: The method of any one of embodiments 1-5, wherein increasing the viscosity of the molten mass is accomplished by cooling the molten mass.

Embodiment 7: The method of any one of embodiments 1-6, wherein the bulk polymer material further comprises a wax, a slip additive, an antiblock additive, a processing aid, or any combination thereof.

Embodiment 8: The method of embodiment 7, wherein the bulk polymer material further comprises a wax, the wax comprising EBS (ethylene-bis staramide) synthetic wax.

Embodiment 9: The method of any one of embodiments 1-8, wherein the forming comprises orienting the molten mass.

Embodiment 10: The method of embodiment 9, wherein the orienting occurs at a temperature from about 100° F. to about 180° F.

Embodiment 11: The method of embodiment 9 or 10, wherein the orienting occurs in a vertically upward direction.

Embodiment 12: The method of any one of embodiments 1-11, further comprising annealing the biopolyester blown film.

Embodiment 13: The method of any one of embodiments 1-12, wherein the first viscosity is from about 1400 P to about 1600 P at an apparent shear rate of about 55 s⁻¹.

Embodiment 14: The method of any one of embodiments 1-13, wherein the melting is performed at a temperature from about 340° F. to about 350° F.

Embodiment 15: The method of any one of embodiments 1-14, further comprising drying the bulk polymer material prior to the melting.

Embodiment 16: The method of embodiment 15, wherein the moisture content of the bulk polymer material is about 400 ppm or less.

Embodiment 17: A home-compostable biopolyester blown film comprising: a biopolyester selected from the group consisting of polyhydroxyalkanoate (PHA), polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof; a wax; and an enzyme.

Embodiment 18: The blown film of embodiment 17, wherein the wax comprises EBS (ethylene-bis staramide) synthetic wax.

Embodiment 19: The blown film of embodiment 17 or embodiment 18, further comprising a plasticizer in an amount of less than about 2% by weight of the blown film.

Embodiment 20: The blown film of any one of embodiments 17-19, wherein the blown film is free of a plasticizer.

What is claimed is:

1. A method of making a home-compostable biopolyester blown film, the method comprising:
melting a bulk polymer material to form a molten mass having a first viscosity;
increasing the viscosity of the molten mass to a second viscosity;
applying one or more enzymes to the molten mass within a climate-controlled enclosure;
forming a bubble from the molten mass within the climate-controlled enclosure; and
collapsing the bubble to form a film within the climate-controlled enclosure.

2. The method of claim 1, wherein the bulk polymer material includes a biopolyester selected from the group consisting of polyhydroxyalkanoate (PHA), polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof.

3. The method of claim 2, wherein the biopolyester includes PHA.

4. The method of claim 1, wherein the bulk polymer material includes a plasticizer in an amount of less than 2% by weight.

5. The method of claim 1, wherein the bulk polymer material is free of a plasticizer.

6. The method of claim 1, wherein increasing the viscosity of the molten mass is accomplished by cooling the molten mass.

7. The method of claim 1, wherein the bulk polymer material further comprises a wax, a slip additive, an antiblock additive, a processing aid, or any combination thereof.

8. The method of claim 7, wherein the bulk polymer material further comprises a wax, the wax comprising EBS (ethylene-bis staramide) synthetic wax.

9. The method of claim 1, wherein the forming comprises orienting the molten mass.

10. The method of claim 9, wherein the orienting occurs at a temperature from about 100° F. to about 180° F.

11. The method of claim 9, wherein the orienting occurs in a vertically upward direction.

12. The method of claim 1, further comprising annealing the biopolyester blown film.

13. The method of claim 1, wherein the first viscosity is from about 1400 P to about 1600 P at an apparent shear rate of about 55 s⁻¹.

14. The method of claim 1, wherein the melting is performed at a temperature from about 340° F. to about 350° F.

15. The method of claim 1, further comprising drying the bulk polymer material prior to the melting.

16. The method of claim 15, wherein the moisture content of the bulk polymer material is about 400 ppm or less.

17. A home-compostable biopolyester blown film comprising:
a biopolyester selected from the group consisting of polyhydroxyalkanoate (PHA), polylactic acid (PLA) (such as poly(L-lactic acid) (PLLA), poly(D-lactic acid) (PDLA), poly(D,L-lactic acid) (PDLLA) or PLA stereocomplex (scPLA)), polyglycolic acid (PGA), polycaprolactone (PCL), polybutylene succinate (PBS), polybutylene succinate adipate (PBSA), polybutylene adipate terephthalate (PBAT), and derivatives or combinations thereof;
a wax; and
an enzyme.

18. The blown film of claim 17, wherein the wax comprises EBS (ethylene-bis staramide) synthetic wax.

19. The blown film of claim 17, further comprising a plasticizer in an amount of less than about 2% by weight of the blown film.

20. The blown film of claim 17, wherein the blown film is free of a plasticizer.
